(19) United States
(12) Patent Application Publication
(10) Pub. No.: US 2019/0022961 A1
(43) Pub. Date: Jan. 24, 2019

(54) METHOD FOR FUSED FILAMENT FABRICATION OF A THERMOPLASTIC PART INCLUDING INDUCTION HEATING

(71) Applicant: GM GLOBAL TECHNOLOGY OPERATIONS LLC, Detroit, MI (US)

(72) Inventors: Julien P. Mourou, Bloomfield Hills, MI (US); Paul J. Wolcott, Macomb, MI (US)

(73) Assignee: GM GLOBAL TECHNOLOGY OPERATIONS LLC, Detroit, MI (US)

(21) Appl. No.: 15/653,018

(22) Filed: Jul. 18, 2017

(51) Int. Cl. B29C 71/00; B29C 64/118; B29C 64/209; B33Y 10/00; B33Y 30/00; B33Y 70/00

(52) U.S. Cl. CPC B29C 71/0072; B29C 64/118; B29C 64/209; B29K 2505/12; B33Y 30/00; B33Y 70/00; B33Y 10/00

(57) ABSTRACT

A method for fused filament fabrication of a thermoplastic part includes: mixing an additive material that is electrically conductive with a thermoplastic material; forming a filament made of materials that include the thermoplastic material mixed with the additive material: passing the filament through an alternating magnetic field such that the additive material is heated by the alternating magnetic field and thus heats the thermoplastic material of the filament; and depositing the materials of the filament on a previously deposited layer of the part to form a newly deposited layer of the part. The thermoplastic material in the newly deposited layer is sufficiently heated such that the thermoplastic material of the newly deposited layer fuses with the thermoplastic material of the previously deposited layer. The method may include: extruding the materials of the filament through a nozzle; and continuing to deposit the materials of the filament until the part is manufactured.

### INTRODUCTION

Additive Manufacturing is a field of manufacturing processes that creates three dimensional parts directly from digital data through successive addition of layers of material. Additive Manufacturing can be used to produce both prototype parts and limited volume production parts. Fused Filament Fabrication is one type of Additive Manufacturing process. In the Fused Filament Fabrication process, a thermoplastic material is extruded through a heated nozzle and deposited on the part being manufactured. This disclosure relates to the Fused Filament Fabrication type of Additive Manufacturing process.

### SUMMARY

A method for fused filament fabrication of a thermoplastic part is disclosed herein. The method includes mixing an additive material that is electrically conductive with a thermoplastic material; forming a filament made of materials that include the thermoplastic material mixed with the additive material: passing the filament through an alternating magnetic field such that the additive material is heated by the alternating magnetic field and thus the inductively heated additive material heats the thermoplastic material of the filament; and depositing the materials of the filament on a previously deposited layer of the part to form a newly deposited layer of the part. The thermoplastic material in the newly deposited layer is sufficiently heated such that the thermoplastic material of the newly deposited layer fuses with the thermoplastic material of the previously deposited layer.

The method may include generating an alternating magnetic field. Generating the alternating magnetic field may include passing alternating electrical current through a coil of electrically conductive wire. Passing the filament through the alternating magnetic field may include continuously feeding the filament through the alternating magnetic field. The method may include extruding the materials of the filament through a nozzle. The method may include continuing to deposit the materials of the filament on the previously deposited layer to form additional newly deposited layers until the part is manufactured.

The nozzle may be configured to deposit the materials of the filament on the previously deposited layer to form the newly deposited layer. The coil of electrically conductive wire may encircle at least a portion of the nozzle such that the filament is heated as it passes through the nozzle. The nozzle may be made of a material that is not electrically conductive such that the nozzle is not heated by the alternating magnetic field. The coil of electrically conductive wire may be disposed within the nozzle.

The additive material may include a ferromagnetic material. The additive material may include a ferrimagnetic material. The additive material may include iron. The thermoplastic material may include one of Acrylonitrile Butadiene Styrene (ABS), Polylactide (PLA), Polyetherimedie (PEI), and nylon materials.

The additive material may be configured as a multiplicity of granular shaped particles configured to reinforce the thermoplastic part. The additive material may be configured as a multiplicity of short fibers, each having a length and a width. The length of each short fiber may be greater than the width of each short fiber. The multiplicity of short fibers may be randomly oriented in the filament and may be configured to reinforce the thermoplastic part. The filament may have a longitudinal axis. The additive material may be configured as at least one wire or continuous fiber having a longitudinal axis. The longitudinal axis of the at least one wire or continuous fiber may be parallel to the longitudinal axis of the filament. The at least one wire or continuous fiber may be configured to reinforce the thermoplastic part.

The filament may further include a reinforcement material configured to reinforce the thermoplastic part. The reinforcement material may be configured as a multiplicity of granular shaped particles. The reinforcement material may be configured as a multiplicity of short fibers, each having a length and a width. The length of each short fiber may be greater than the width of each short fiber. The multiplicity of short fibers may be randomly oriented in the filament. The reinforcement material may be configured as at least one continuous fiber having a longitudinal axis. The longitudinal axis of the continuous fiber may be parallel to the longitudinal axis of the filament.

The method disclosed herein includes induction heating of the filament. Induction heating of the filament results in faster and more uniform heating of the filament from the inside of the filament. Inductive heating of the filament eliminates the need to heat the nozzle and to transfer heat from the nozzle to the filament. Inductive heating of the filament enables faster filament heating, faster part manufacturing, and reduced energy use compared to conductively heating of the filament via a heated nozzle, for example an electrical resistance heated nozzle. This disclosure applies to fused filament fabrication of a thermoplastic part for a vehicle, including but not limited to cars, trucks, vans, all-terrain vehicles, busses, boats, trains, airplanes, manufacturing vehicles and equipment, construction vehicles and equipment, maintenance vehicles and equipment, etc. This disclosure applies to fused filament fabrication of a thermoplastic part for a machine or manufacture.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic, cross-sectional illustration, partially in elevation, of an example apparatus for fused filament fabrication of a thermoplastic part of the type disclosed herein, with an induction heating element disposed inside of a nozzle.

FIG. 2 is a schematic, side view illustration of the example apparatus for fused filament fabrication of the thermoplastic part of FIG. 1, with the induction heating element disposed outside of the nozzle.

FIG. 3 is a flowchart of an example method for fused filament fabrication of a thermoplastic part including induction heating.

FIG. 4A is a fragmentary, schematic, perspective illustration of a first example filament that may be used in the method of FIG. 3, including electrically conductive additive material particles mixed with a thermoplastic material, with the thermoplastic material shown in phantom.

FIG. 4B is a schematic, cross-sectional illustration of the example filament of FIG. 4A.

FIG. 4C is a close up of the electrically conductive additive material particles mixed with the thermoplastic material at circle 4C of FIG. 4A, with the thermoplastic material shown in phantom.

FIG. 5A is a fragmentary, schematic, perspective illustration of a second example filament that may be used in the method of FIG. 3, including electrically conductive additive material short fibers mixed with the thermoplastic material, with the thermoplastic material shown in phantom.

FIG. 5B is a schematic, cross-sectional illustration of the example filament of FIG. 5A.

FIG. 5C is a close up of the electrically conductive additive material short fibers mixed with the thermoplastic material at circle 5C of FIG. 5A, with the thermoplastic material shown in phantom.

FIG. 6A is a fragmentary, schematic, perspective illustration of a third example filament that may be used in the method of FIG. 3, including at least one electrically conductive additive material wire or continuous fiber mixed with the thermoplastic material, with the thermoplastic material shown in phantom.

FIG. 6B is a schematic, cross-sectional illustration of the example filament of FIG. 6A.

FIG. 7A is a fragmentary, schematic, perspective illustration of a fourth example filament that may be used in the method of FIG. 3, including electrically conductive additive material particles and continuous reinforcement fibers mixed with the thermoplastic material, with the thermoplastic material shown in phantom.

FIG. 7B is a schematic, cross-sectional illustration of the example filament of FIG. 7A.

FIG. 7C is a close up of the electrically conductive additive material particles mixed with the thermoplastic material at circle 7C of FIG. 7A, with the thermoplastic material shown in phantom.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims.

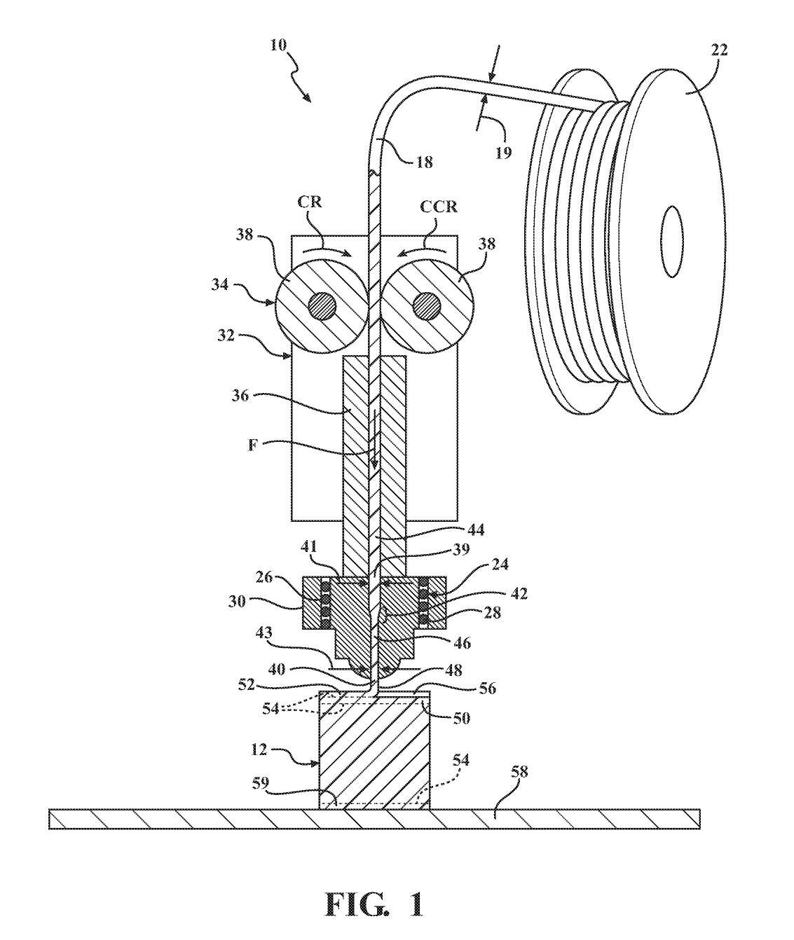

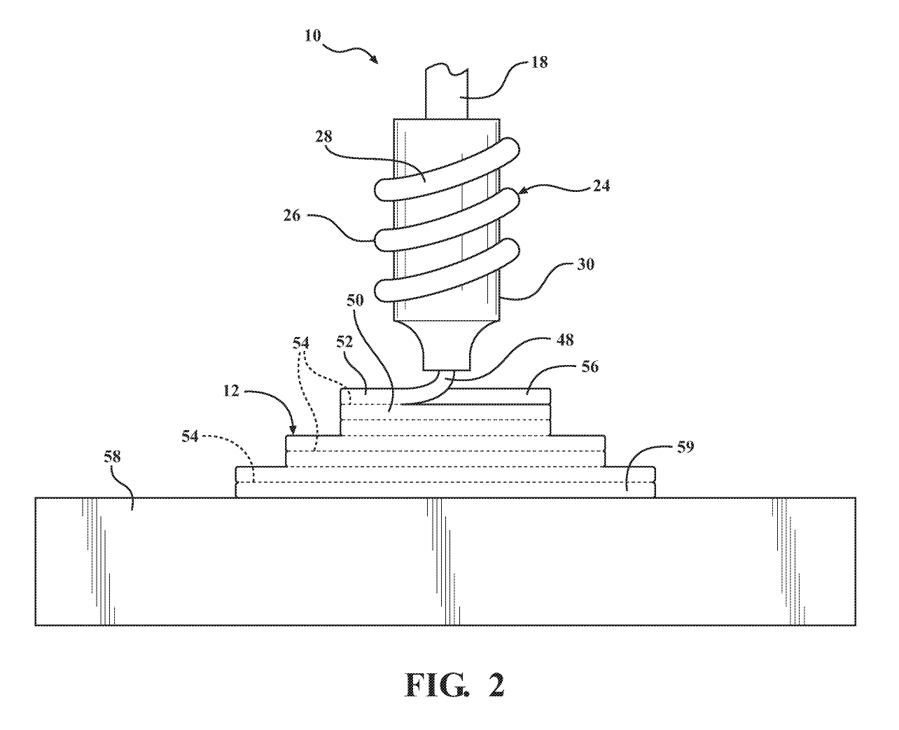

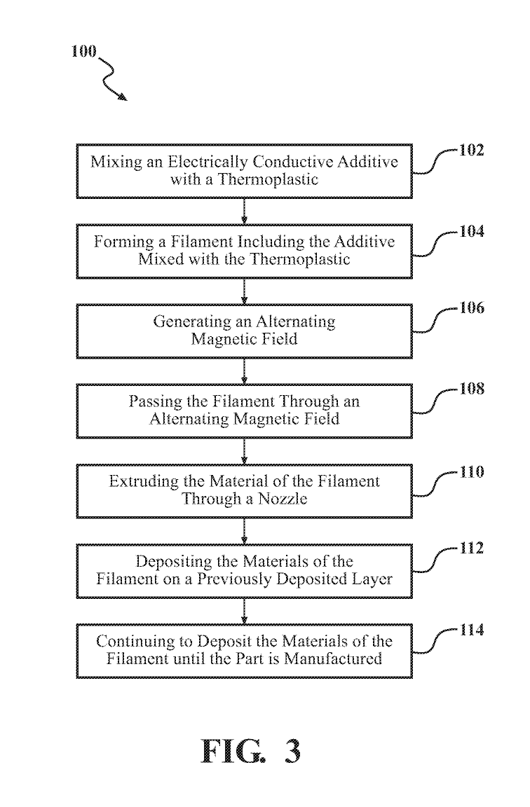

Referring to the drawings, wherein like reference numbers refer to like components throughout the views, FIGS. 1 and 2 show an example apparatus 10 for an example method 100 for fused filament fabrication of a thermoplastic part 12 including induction heating. FIG. 3 shows an example flowchart of the method 100 for fused filament fabrication of a thermoplastic part 12 including induction heating. The example apparatus 10 and the example method 100 may be applied to fused filament fabrication of a thermoplastic part 12 for a vehicle (not shown). For example, thermoplastic parts 12 such as switches, knobs, interior components, and trim parts may be manufactured using example apparatus 10 and method 100. In addition, the example apparatus 10 and method 100 may be applied to fused filament fabrication of another type of thermoplastic part for another machine or manufacture.

Referring now to FIGS. 1-4C, the method 100 includes, at step 102, mixing an additive material 14 that is electrically conductive with a thermoplastic material 16. Mixing of the additive material 14 with the thermoplastic material 16 may result in a uniform distribution of the additive material 14 within the thermoplastic 16. Mixing of the additive material 14 with the thermoplastic material 16 may be accomplished by a variety of methods, as understood by those skilled in the art.

The additive material 14 is an electrically conductive material. The additive material 14 may be a ferromagnetic material. A ferromagnetic material is defined herein as a material that can be magnetized to form a permanent magnet. Examples of ferromagnetic material include, but are not limited to iron, nickel, cobalt and most of their alloys, some compounds of rare earth metals, and some varieties of lodestone. The additive material 14 may include a ferrimagnetic material. A ferrimagnetic material is defined herein as a material that has populations of atoms with opposing magnetic moments. The magnetic moments of neighboring atoms point in opposite directions, with a net magnetization still resulting because of differences in the magnitudes of the opposite moments. Examples of ferrimagnetic materials include, but are not limited to ferrites, magnetic garnets, and magnetite. The additive material 14 may include a metal. The additive material 14 may include iron.

The thermoplastic material 16 may include one of Acrylonitrile Butadiene Styrene (ABS), Polylactide (PLA), Polyetherimedie (PEI), and nylon materials. The thermoplastic material 16 may be another thermoplastic material, as appropriate to the requirements of the part 12 being manufactured. A thermoplastic material or thermoplastic is defined herein as a material that becomes soft when heated and re-hardens on cooling without an appreciable change of properties. A thermoplastic part 12 is defined herein as a part made of materials that include a thermoplastic material. The thermoplastic part 12 may further include other materials, including but not limited to filler materials, reinforcement materials, pigment materials, and other materials that change, modify, and/or improve the material properties of the thermoplastic material 16 in the thermoplastic part 12.

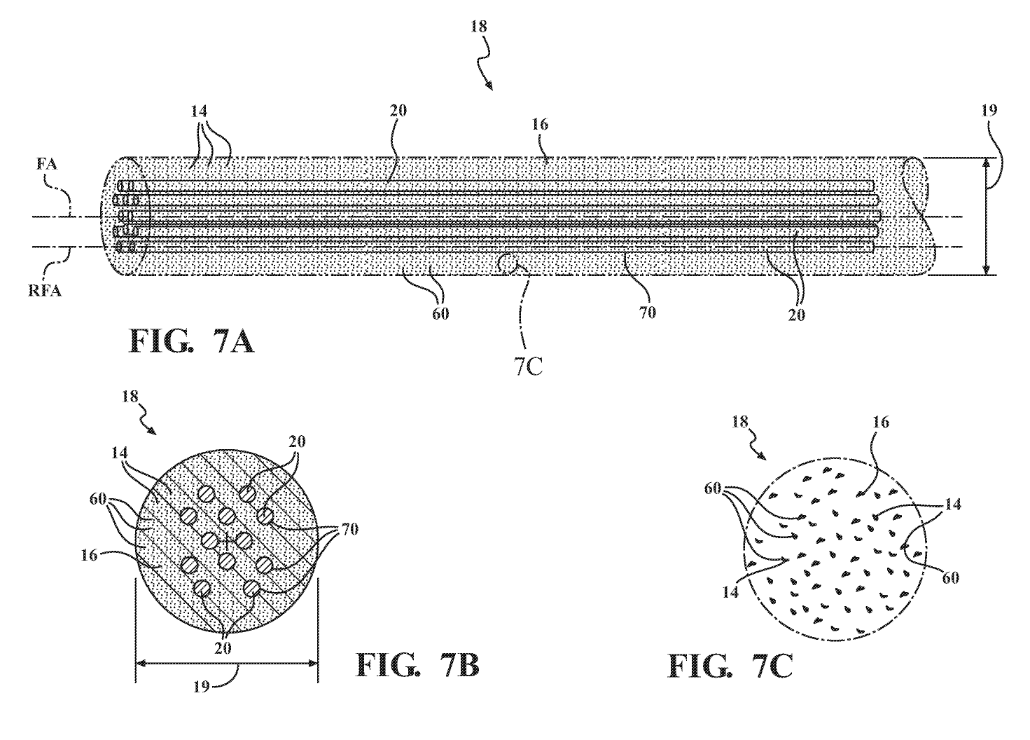

The method 100 includes, at step 104, forming a filament 18 made of materials that include the thermoplastic material 16 mixed with the additive material 14. Referring now to FIGS. 7A and 7B, the filament 18 may further include a reinforcement material 20. The filament 18 has a filament longitudinal axis (axis FA) and may have a filament diameter 19, perpendicular to the filament longitudinal axis (axis FA). The reinforcement material 20 may be configured to reinforce the thermoplastic part 12 to improve the strength, stiffness, and/or other material properties of the thermoplastic material 16 of the thermoplastic part 12. The reinforcement material 20 may be the same material as the additive material 14, or alternatively may be a different material from the additive material 14. The reinforcement material 20 may be one of a glass material, a carbon material, and a metal material.

Referring again to FIGS. 1-4C, forming of the filament 18 may be accomplished by methods, as understood by those skilled in the art. The filament 18 may be stored on a spool 22. The filament 18 may be removed or unwound from the spool 22 as needed in the method 100.

The method 100 may include, at step 106, generating an alternating magnetic field (not shown). Generating the alternating magnetic field may include passing alternating electrical current (not shown) through an induction heating element 24. The induction heating element 24 may include a coil 26 of electrically conductive wire 28. The coil 26 of electrically conductive wire 28 may generate the alternating magnetic field within the coil 26 and surrounding the coil 26 when the alternative electrical current is passed through the coil 26 of electrically conductive wire 28. Generating the alternating magnetic field may be accomplished through the use of other types and configurations of induction heating elements 24, as understood by those skilled in the art.

The method 100 includes, at step 108, passing the filament 18 through the alternating magnetic field such that the additive material 14 is inductively heated by the alternating magnetic field and thus the inductively heated additive material 14 heats the materials 14, 16, 20 of the filament 18 quickly and uniformly from the inside of the filament 18. The uniform distribution of the additive material 14 within the thermoplastic material 16 may uniformly heat the thermoplastic material 16 as the filament 18 is passed through the alternating field and the additive material 14 is inductively heated. Passing the filament 18 through the alternating magnetic field may include continuously feeding the filament 18 in a feed direction (arrow F) through the alternating magnetic field.

Inductive heating of the filament 18 may eliminate heating of the nozzle 30, for example by resistance heating. Inductive heating of the filament 18 may eliminate transferring heat conductively from the nozzle 30 to the filament 18 and within the filament 18. Inductive heating of the filament 18 may more rapidly and more uniformly heat the filament 18 compared to conductive heating of the filament 18 by eliminating conductive heat transfer from the nozzle 30 to the filament 18 and within the filament 18. Inductive heating of the filament 18 may allow faster part manufacturing compared to conducive heating of the filament 18 due to the more rapid and more uniform heating of the filament 18. Inductive heating of the filament 18 may reduce energy use compared to conductive heating of the filament 18 by eliminating heating of the nozzle 30 and thus heat losses from the nozzle 30, and by eliminating transferring of heat conductively from the nozzle 30 to the filament 18 and within the filament 18.

The method 100 may include, at step 110, extruding the materials 14, 16, 20 of the filament 18 through a nozzle 30. Extruding 110 may be accomplished with an extruder 32. The extruder 32 may include a drive mechanism 34, a feed tube 36, the nozzle 30, and the induction heating element 24.

The drive mechanism 34 may include one or more drive wheels 38 that are driven by a motor (not shown) and configured to push the filament 18 via traction into the feed tube 36 and the nozzle 30. The drive wheels 38 may be rotated in a clockwise rotation direction (arrow CR) or in a counter clockwise rotation direction (arrow CCR), as appropriate, to push the filament 18 via traction in the feed direction (arrow F) into the feed tube 36 and the nozzle 30. The feed tube 36 may be configured to surround and guide the filament 18 toward and into the nozzle 30.

The nozzle 30 may form an entrance orifice 39 having an entrance orifice diameter 41 and an exit orifice 40 and an exit orifice 40 having an exit orifice diameter 43. The diameter 41 of the entrance orifice 39 may be the same as the diameter 19 of the filament 18. The diameter 41 of the entrance orifice 39 may be larger than the diameter 43 of the exit orifice 40, as shown. The nozzle 30 may include a transition zone 42, where the transition between the diameter 41 of the entrance orifice 39 and the diameter 43 of the exit orifice 40 occurs. Alternatively, the diameter 41 of the entrance orifice 39 may be the same as the diameter 43 of the exit orifice 40.

The filament 18 may be in a solid or unheated state 44 at the entrance orifice 39 of the nozzle 30. The filament 18 may be in a softened or heated state 46 at the exit orifice 40 of the nozzle 30. The thermoplastic material 16 of the softened or heated state 46 of the filament 18 is softer than thermoplastic material 16 of the solid or unheated state 44 of the filament 18. The thermoplastic material 16 of the filament 18 in the softened or heated state 46 may be sufficiently softened such that a softened bead 48 of the materials 14, 16, 20 of the filament exits the exit orifice 40 of the nozzle 30.

The induction heating element 24 may be disposed within the nozzle 30, as shown in FIG. 1. The coil 26 of electrically conductive wire 28 may be disposed within the nozzle 30 such that the filament 18 is heated from the solid or unheated state 44 to the softened or heated state 46 as it passes through the nozzle 30. Alternatively, the induction heating element 24 may be disposed outside of the nozzle 30, as shown in FIG. 2. The coil 26 of electrically conductive wire 28 may encircle at least a portion of the nozzle 30 such that the filament 18 is heated as it passes through the nozzle 30.

Referring again to FIGS. 1-4C, the nozzle 30 may be made of a material that is not electrically conductive such that the nozzle 30 is not heated by the alternating magnetic field. The nozzle 30 may be made of material that is not a ferromagnetic or a ferrimagnetic material. The induction heating element 24 may be configured to heat the filament 18 as the filament 18 passes through the nozzle 30. The induction heating element 24 may be configured to heat of the filament 18 as it passes through the transition zone 42 of the nozzle 30. The induction heating element 24 may be configured to not heat the filament 18 until the filament 18 enters the transition zone 42 of the nozzle 30.

The method 100 includes, at step 112, depositing the materials 14, 16, 20 of the filament 18 on a previously deposited layer 50 of the thermoplastic part 12 to form a newly deposited layer 52 of the thermoplastic part 12. The thermoplastic material 16 in the newly deposited layer 52 is sufficiently heated such that the thermoplastic material 16 of the newly deposited layer 52 fuses with the thermoplastic material 16 of the previously deposited layer 50 forming a fused attachment 54 between the previously deposited layer 50 and the newly deposited layer 52.

The thermoplastic material 16 in the newly deposited layer 52 may be sufficiently heated such that the thermoplastic material 16 of the newly deposited layer 52 fuses with both the thermoplastic material 16 of the previously deposited layer 50 and with the thermoplastic material 16 of a previously deposited bead or row 56 of the newly deposited layer 52 forming a fused attachment 54 with both the previously deposited layer 50 and the previously deposited row 56 of the newly deposited layer 52. Fuse is defined herein as to attach or unite into a whole, by melting together. The nozzle 30 and the exit orifice 40 may be configured to deposit the materials 14, 16, 20 of the filament 18 on the previously deposited layer 50 to form the newly deposited layer 52.

The method 100 may include, at step 114, continuing to deposit the materials 14, 16, 20 of the filament 18 on the previously deposited layer 50 to form additional newly deposited layers 52 until the thermoplastic part 12 is manufactured or completed.

The thermoplastic part 12 may be connected to a part support 58 during execution of the method 100 for fused filament fabrication of a thermoplastic part 12 including induction heating. A first layer 59 of the thermoplastic part 12 may be deposited on the part support 58. The part support 58 and/or the extruder 32 may move relative to one another as appropriate during execution of the method 100.

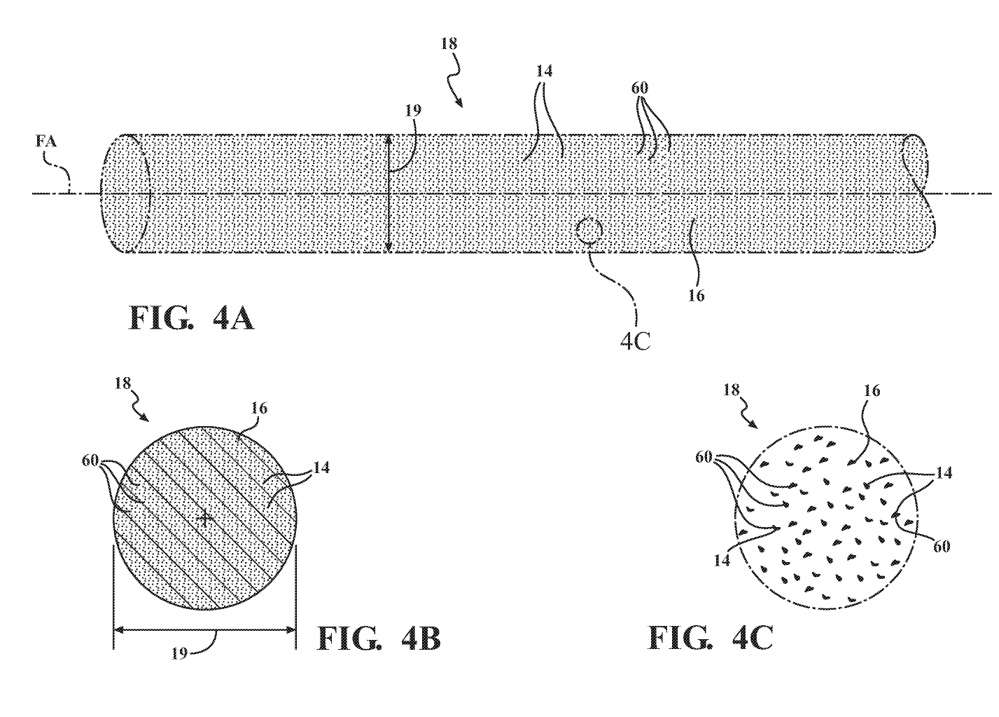

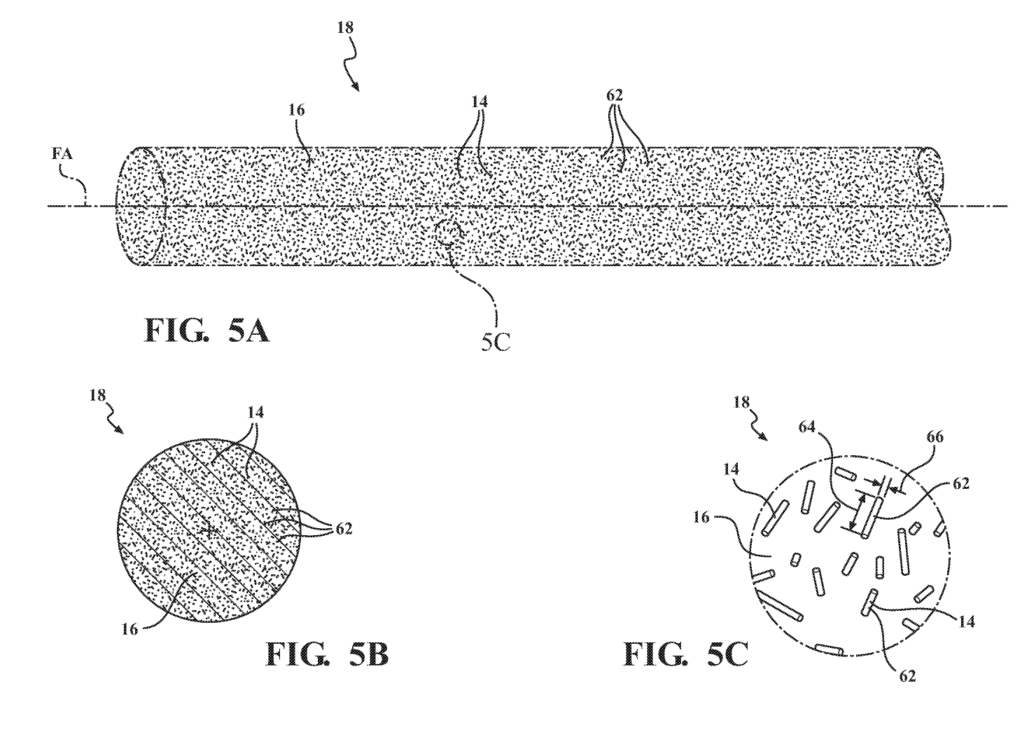

Referring now specifically to FIGS. 4A-4C, the additive material 14 may be configured as a multiplicity of granular shaped particles 60 configured to reinforce the thermoplastic part 12. Referring now to FIGS. 5A-5C, the additive material 14 may be configured as a multiplicity of short fibers 62, each having a length 64 and a width 66. The length 64 of each short fiber 62 may be greater than the width 66 of each short fiber 62. The multiplicity of short fibers 62 may be randomly oriented in the filament 18 and may be configured to reinforce the thermoplastic part 12.

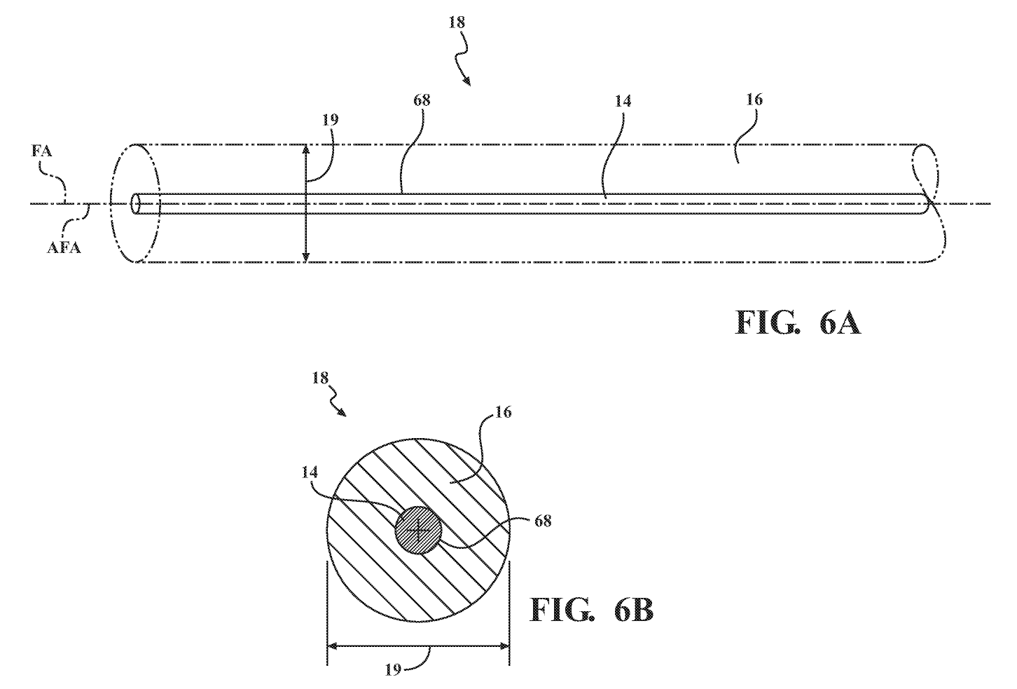

Referring now to FIGS. 6A and 6B, the additive material 14 may be configured as at least one continuous wire or fiber 68 having an additive material fiber longitudinal axis (axis AFA). The additive material fiber longitudinal axis (axis AFA) of the at least one continuous fiber 68 may be parallel to the filament longitudinal axis (axis FA) of the filament 18. The additive material fiber longitudinal axis (axis AFA) of the at least one continuous fiber 68 may be coincident with the filament longitudinal axis (axis FA), as shown. The at least one continuous fiber 68 may be configured to reinforce the thermoplastic part 12.

Referring now to FIGS. 7A-7C, the filament 18 may include both the additive material 14 and the reinforcement material 20. The reinforcement material 20 may be configured as at least one continuous fiber 70 having a reinforcement material fiber longitudinal axis (axis RFA). The reinforcement material fiber longitudinal axis (axis RFA) of the continuous fiber 70 may be parallel to the filament longitudinal axis (axis FA) of the filament 18. The reinforcement material fiber longitudinal axis (axis RFA) of the at least one continuous fiber 70 may be coincident with the filament longitudinal axis (axis FA).

It should be recognized that the granular shaped particles 60, the short fibers 62, and the continuous fibers 68 of the additive material 14 may be combined with granular shaped particles (not shown), short fibers (not shown), or the continuous fibers 70 of the reinforcement material 20 in the filament 18. For example, the additive material 14 may be configured as the granular shaped particles 60, and the reinforcement material 20 may be configured as granular shaped particles. In another example, the additive material 14 may be configured as the granular shaped particles 60 and the reinforcement material 20 may be configured as as short fibers, each having a length and a width. The length of each short fiber of the reinforcement material 20 may be greater than the width of each short fiber of the reinforcement material 20. The multiplicity of short fibers of the reinforcement material 20 may be randomly oriented in the filament 18.

The filament 18 and orifices 39, 40 described herein is shown as having a circular or round cross-section shape perpendicular to the filament longitudinal axis (axis FA). However, it should be appreciated that the cross-section shape of the filament 18 and the orifices 39, 40 may differ from the exemplary circular or round cross-section shape shown and described herein.

While the best modes for carrying out the disclosure have been described in detail, those familiar with the art to which this disclosure relates will recognize various alternative designs and embodiments for practicing the disclosure within the scope of the appended claims.

What is claimed is:

1. A method for fused filament fabrication of a thermoplastic part, comprising:
mixing an additive material that is electrically conductive with a thermoplastic material;
forming a filament made of materials that include the thermoplastic material mixed with the additive material;
passing the filament through an alternating magnetic field such that the additive material is inductively heated by the alternating magnetic field and thus heating the thermoplastic material of the filament; and
depositing the materials of the filament on a previously deposited layer of the part to form a newly deposited layer of the part; and
wherein the thermoplastic material in the newly deposited layer is sufficiently heated such that the thermoplastic material of the newly deposited layer fuses with the thermoplastic material of the previously deposited layer.

2. The method of claim 1, further comprising extruding the materials of the filament through a nozzle;
wherein the nozzle is configured to deposit the materials of the filament on the previously deposited layer to form the newly deposited layer.

3. The method of claim 1, further comprising continuing to deposit the materials of the filament on the previously deposited layer to form additional newly deposited layers until the part is manufactured.

4. The method of claim 1, wherein the additive material includes a ferromagnetic material.

5. The method of claim 1, wherein the additive material includes a ferrimagnetic material.

6. The method of claim 1, wherein the additive material is configured as a multiplicity of granular shaped particles configured to reinforce the thermoplastic part.

7. The method of claim 1, wherein the additive material is configured as a multiplicity of fibers, each having a length and a width;
wherein the length of each fiber is greater than the width of each fiber; and
wherein the multiplicity of fibers are randomly oriented in the filament and are configured to reinforce the thermoplastic part.

8. The method of claim 1, wherein the filament has a longitudinal axis;
wherein the additive material is configured as at least one continuous fiber having a longitudinal axis;
wherein the longitudinal axis of the continuous fiber is parallel to the longitudinal axis of the filament; and
wherein the at least one continuous fiber is configured to reinforce the thermoplastic part.

9. The method of claim 1, wherein filament further includes a reinforcement material configured to reinforce the thermoplastic part.

10. The method of claim 9, wherein the reinforcement material is configured as a multiplicity of granular shaped particles.

11. The method of claim 9, wherein the reinforcement material is configured as a multiplicity of fibers, each having a length and a width;
wherein the length is greater than the width; and
wherein the multiplicity of fibers are randomly oriented in the filament.

12. The method of claim 9, wherein the filament has a longitudinal axis;
wherein the reinforcement material is configured as at least one continuous fiber having a longitudinal axis; and
wherein the longitudinal axis of the continuous fiber is parallel to the longitudinal axis of the filament.

13. The method of claim 1, further comprising generating an alternating magnetic field.

14. The method of claim 13, wherein generating the alternating magnetic field includes passing alternating electrical current through a coil of electrically conductive wire.

15. The method of claim 14, further comprising extruding the materials of the filament through a nozzle;
wherein the nozzle is configured to deposit the materials of the filament on the previously deposited layer to form the newly deposited layer; and
wherein the coil of electrically conductive wire encircles at least a portion of the nozzle such that the filament is heated as it passes through the nozzle.

16. The method of claim 15, wherein the nozzle is made of a material that is not electrically conductive such that the nozzle is not heated by the alternating magnetic field.

17. The method of claim 15, wherein the coil of electrically conductive wire is disposed within the nozzle.

18. The method of claim 1, wherein passing the filament through the alternating magnetic field includes continuously feeding the filament through the alternating magnetic field.

19. The method of claim 1, wherein the thermoplastic material includes one of Acrylonitrile Butadiene Styrene (ABS), Polylactide (PLA), Polyetherimedie (PEI), and nylon.

20. A method for fused filament fabrication of a thermoplastic part, comprising:
mixing an additive material that is electrically conductive with a thermoplastic material;
forming a filament made of materials that include the thermoplastic material mixed with the additive material;
generating an alternating magnetic field;
passing the filament through the alternating magnetic field such that the additive material is inductively heated by the alternating magnetic field and thus heating the thermoplastic material of the filament;
extruding the materials of the filament through a nozzle;
depositing the materials of the filament on a previously deposited layer of the part to form a newly deposited layer of the part; and
continuing to deposit the materials of the filament on the previously deposited layer to form additional newly deposited layers until the part is manufactured;
wherein the additive material includes one of a ferromagnetic material and a ferrimagnetic material;
wherein passing the filament through the alternating magnetic field includes continuously feeding the filament through the alternating magnetic field; and
wherein the thermoplastic material in the newly deposited layer is sufficiently heated such that the thermoplastic material of the newly deposited layer fuses with the thermoplastic material of the previously deposited layer.
